(19) United States
(12) Patent Application Publication
(10) Pub. No.: US 2006/0271385 A1
(43) Pub. Date: Nov. 30, 2006

(54) Apparatus and method for providing a construction warranty program

(75) Inventor: John Hochbaum, Chicago, IL (US)

Correspondence Address: Cynthia L. Smith, STE. # 1905, 21 East Huron, Chicago, IL, 60611, US

(73) Assignee: Build Wiser Today

(21) Appl. No.: 11/140,874

(22) Filed: May 31, 2005

(51) Int. Cl. G06Q 99/00

(52) U.S. Cl. 705/1

(57) ABSTRACT

Disclosed is an apparatus and method for providing a construction warranty program that includes a number of purchasable construction warranty plans that when purchased by a registered contractor, do not require the registered contractor to provide evidence of equity or working capital equal to a contract price for a service contract for the registered contractor's construction services. When purchased by the registered contractor, the construction warranty program enables a payment guarantee to the registered contractor by a purchaser of the registered contractor's services under the service contract and a service performance guarantee by the registered contractor to the purchaser for the registered contractor's services under the service contractor. The construction warranty program is accessible to the registered contractor via a construction warranty website.

### CROSS-REFERENCE TO RELATED APPLICATIONS

This application claims benefit under 35 U.S.C. §119(e) of U.S. Provisional Application Ser. No. ______ entitled “An Apparatus and Method for Providing a Construction Warranty Program”, filed on May 9, 2005, naming John Hochbaum as inventor, the complete disclosure thereof being incorporated by reference.

### BACKGROUND OF THE INVENTION

The present invention generally relates to construction guarantees, and more specifically, to an apparatus and method for providing a construction warranty program.

To varying degrees, every construction project includes some uncertainty. Such uncertainty stems for a number of factors including the contractor expertise, economic conditions, building materials, material availability and weather to name a few. Traditionally different types of surety bonds have been utilized as written agreements where one party, typically a Surety, obligates itself to an Obligee (e.g., a home buyer), to answer for the default of a Principle (e.g., a building contractor). Surety bonds are intended to guarantee performance and are therefore generally tailored to meet specific needs.

Surety bonds are generally classified into two categories; a contract surety bond and a commercial surety bond. Contract surety bonds include bid bonds, performance bonds, payment bonds, maintenance bonds and subdivision bonds. A bid bond is designed to provide financial assurance that the bid has been submitted in good faith, and that the Principal intends to enter into the contract at the prices bid and provide the required performance and payment bonds. It affords protection to the Obligee in the event a successful bidder will not enter a contract and will not provide the required surety bonds or other security. A performance bond is designed to protect the Obligee from financial loss should the Principal fail to perform the contract in accordance with its terms and conditions. A payment bond is one which guarantees that the Principal will pay certain subcontractors, laborers, and material suppliers associated with the project. A maintenance bond is designed to guarantee against defective workmanship or material for a specified period. A subdivision bond is designed to guarantee to a city, county or state that the Principal will finance and construct certain improvements such as streets sidewalks, gutters, sewer and drainage system. The second types of surety bonds, commercial surety bonds, include license and permit bonds, judicial and probate bonds (fiduciary bonds), public office bonds and other miscellaneous bonds (e.g., lost securities, employer contributions for Union benefits).

The cost of or premiums paid for surety bonds vary. Typical surety bond premiums range from one-half of one percent to two percent of the contract amount, depending on the size, type and duration of the project and the contractor. In many cases, performance bonds incorporate payment bonds and maintenance bonds. When surety bonds are specified in the contract document, it is the contractor's responsibility to obtain the bonds. The contract generally includes the bond premium amount in the bid and the premium is generally payable upon execution of the bond. If the contract amount changes, the premium will be adjusted for the change in the contract price.

In order to obtain a surety bond, a contractor provides the necessary information to a bond company agent. Based on the contractor's character and past history of fulfilling his or her obligations, the contractor's skill, experience and knowledge, and the contractor's financial wherewithal to support the completion of the project, the bond company agent secures approval from a bond company underwriter. Accordingly, the premium paid for the surety bond is tied to the contractor's character, professional skill and capital.

Most building contractors are required to provide evidence of adequate equity or working capital (current assets minus current liabilities) in order to obtain a surety bond. The working capital required can range anywhere from ten to one-hundred percent of the contract value, thereby limiting, or capping, the amount of and the number of contracts that can be secured by the building contractor. This is a particular hardship for small building contractors and subcontractors. For example, if a roofer can show working capital of $250,000 and is requesting three contract surety bonds to guarantee three separate roofing contracts, each worth $125,000, the Surety may agree to underwrite only two of the contracts. As a result, the roofer will likely lose the third roofing contract to a competitor.

### SUMMARY OF THE INVENTION

In accordance with an embodiment of the invention, provided is an apparatus and method for providing a construction warranty program that includes a number of purchasable construction warranty plans that do not require the Principle, or a registered contractor, to provide evidence of equity or working capital equal to a contract price. When purchased by the registered contractor, a construction warranty program enables a payment guarantee to the registered contractor by a purchaser of the registered contractor's services under the contract and a service performance guarantee by the registered contractor to the purchaser for the registered contractor's services under the contractor.

In accordance with an aspect of the embodiment, provided is an apparatus for providing a construction warranty program. The construction warranty program includes a number of construction warranty plans available to a plurality of registered contractors in good standing with a participating contractor organization. The method includes causing a construction warranty program main page to be displayed, and causing a construction warranty selection page to be displayed in response to detecting entry of valid contractor identity information via the construction warranty program main page. The construction warranty selection page includes a list of the number available construction warranty plans where at least one of the number of available construction warranty plans is purchasable by a registered contractor associated with the entered valid contractor identity information. The method also includes enabling a construction warranty plan of the number of available construction warranty plans to be purchased by and provided to the registered contractor without verifying working capital equivalent to a contract price for the registered contractor's services.

In accordance with another aspect of the embodiment, provided is a method for providing a construction warranty program

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a block diagram of an apparatus that can be used to provide the construction warranty program, according to an embodiment of the invention.

FIG. 2 is a flowchart of a method for providing the construction warranty program, according to an embodiment of the invention.

FIG. 3 is an exemplary construction warranty program main page of the contractor warranty program of FIG. 2, according to an embodiment of the invention.

### DETAILED DESCRIPTION OF THE INVENTION

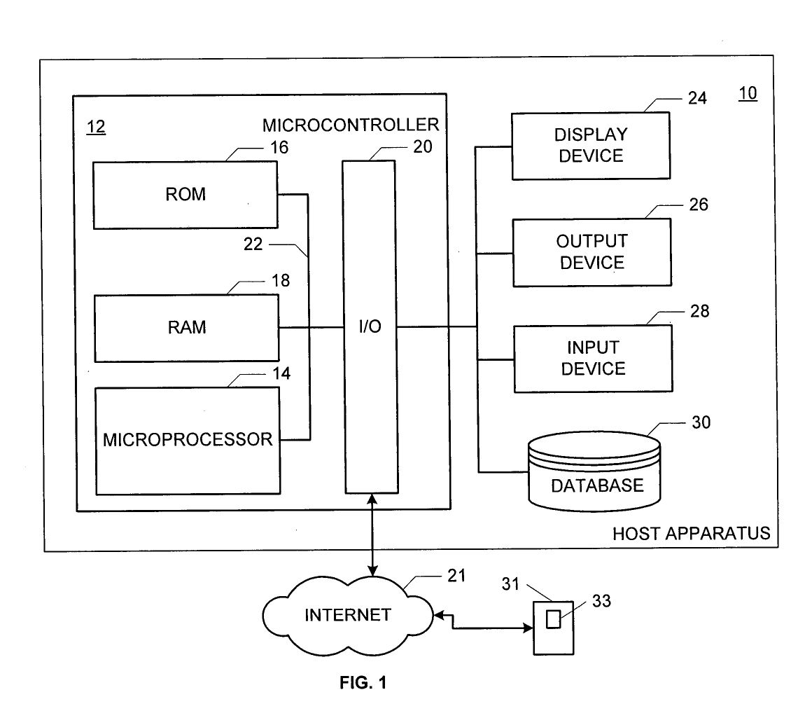

FIG. 1 is a block diagram of an exemplary host apparatus 10 that may be used to provide a construction warranty program, according to an embodiment of the invention. Among other things, the host apparatus 10 is adapted to host a construction warranty program including a construction warranty website. In general, the host apparatus 10 is configured to allow a Registered Contractor or Purchaser, having a suitable configured intelligent remote user device 31 with a display 33 (e.g., a laptop computer, a desktop computer, a personal digital assistant (PDA), a mobile telephone), to access the construction warranty program website via an access network 21.

Referring to FIG. 1, the host apparatus 10 includes a microcontroller 12 including a microcontroller-based platform or microprocessor 14, a read only memory (ROM) 16, a random access memory (RAM) 18, all of which may be interconnected to an input/output circuit 20 via a communications link or an address bus 22. Among other things, the microprocessor 14 is capable of causing images such as construction warranty program web pages to be displayed during execution of the method for providing a construction warranty program (described below). The RAM is capable of storing contractor data or other data used or generated during execution of the method for providing a construction warranty program. The RAM 16 may be implemented as a semiconductor memory, a magnetically readable memory, an optically readable memory, etc. The ROM 16 is capable of storing program code that controls the host apparatus 10 during execution of the construction warranty program.

The host apparatus 10 may also include one or more user input devices 28 which may include a keyboard, a scanner, a mouse, a touch pad, and/or an audio input device and/or a video input device, operatively coupled to the microcontroller 12. Also operatively coupled to the microcontroller 12 may be a display device 24, an output device 26, such as a printer, a fax/modem, etc., and an optional database 30 to store files, programs, web page code, purchase requests, user names and passwords, etc.

Although not separately illustrated, among other things, the host apparatus 10 may further include a network receiver (e.g., an Ethernet interface circuit electrically coupled to the Internet via an Ethernet cable), operatively coupled to the Internet, for purposes of receiving web page requests, construction warranty program purchase requests, usernames and passwords, etc, in a well known manner. Similarly, the host apparatus 10 may also include a network transmitter for purposes of transmitting web pages associated with the construction warranty program, billing information and other data, etc., in a well known manner.

It should be appreciated that although the microcontroller 12 is a preferable implementation of the invention, it is contemplated that the apparatus 10 may also be configured with a field programmable gate array (FPGA), one or more application specific integrated circuits (ASICs), adaptable computing integrated circuits, or any other suitable central processing unit. In addition, although only one microprocessor 14, one RAM 18 and one ROM 16 is shown, the apparatus may include multiple microprocessors, RAMs and/or ROMs.

One manner in which the host apparatus 10 may operate is described below in connection with one or more flowcharts that represent a number of portions or routines of one or more computer programs, which may be stored in one or more of the memories of the apparatus 10, or may be stored remotely. Accordingly, the database(s) 30 may be further adapted to store information and/or data, utilized in the portions or routines of the one or more computer programs.

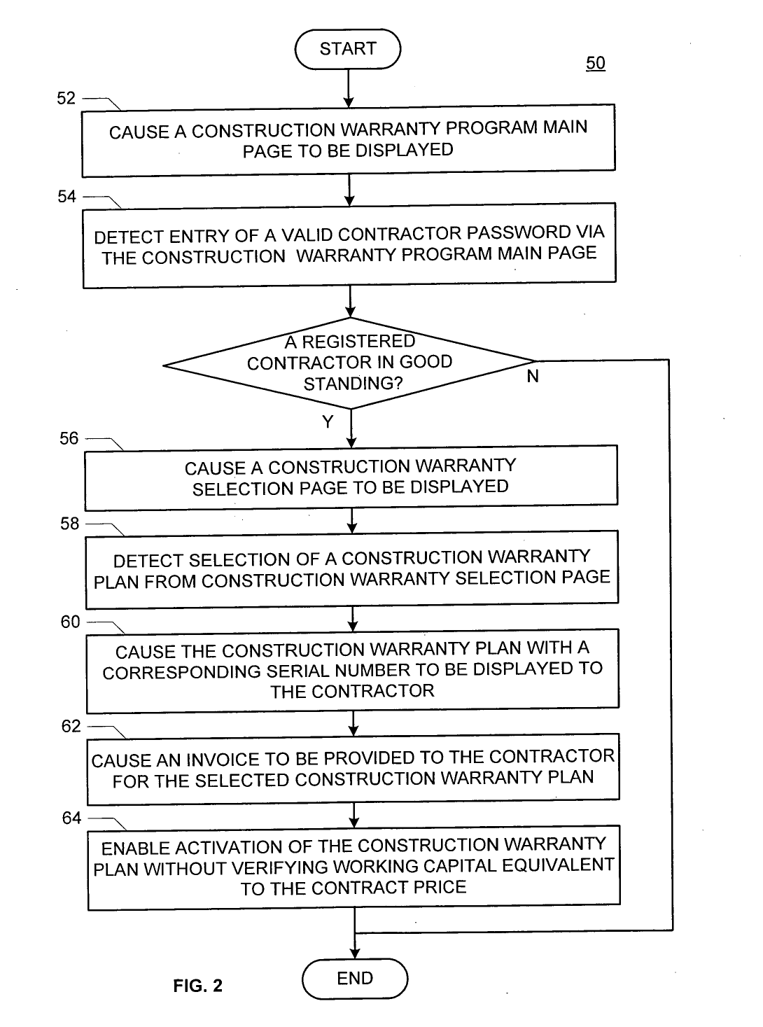

FIG. 2 is a flowchart of a method for providing the construction warranty program 50 using the host apparatus 10 of FIG. 1, according to an embodiment of the invention. As described below, the construction warranty program 50 is applicable for use with many types of contractor services provided via contractors registered (“Registered Contractor”) with one of any number building/construction contractor organizations, such as, for example, the National Roofing Contractors Association (NRCA), the National Kitchen and Bath Association (NKBA), the National Association of Home Builders (NAHB) and the National Association of the Remodeling Industry (NARI). Registered Contractors are defined herein as contractors who are good-standing members of their associated contractor organization.

In general, the construction warranty program 50 provides one or more construction warranty plans, where each construction warranty plan provides a guarantee to a Purchaser of contractor services such as, for example, roofing construction services, that the contractor services contracted for will be delivered per the terms of a service contract (“Contract”) between the Registered Contractor and the Purchaser, or that the Purchaser will be made whole if the services contracted for are not delivered, wholly or partially. Each construction guarantee plan also provides a guarantee to the Registered Contractor that he/she will be paid for all contracted services provided to the Purchaser. Further, acquisition of such a guarantee via one of the construction guarantee plans does not require the Registered Contractor to provide evidence of equity or working capital equal to the contract price; rather, the Registered Contractor must provide evidence that he/she is a Registered Contractor in good-standing with his/her affiliated building/construction contractor organization.

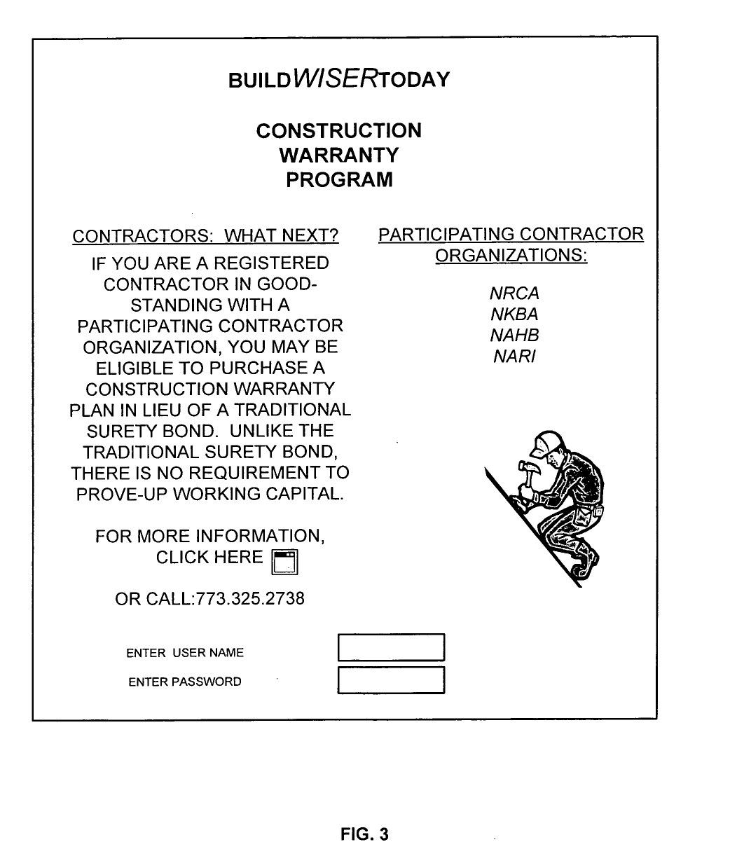

Referring to FIG. 2, the construction warranty program 50 begins when the microcontroller 12 causes a construction warranty program main page to be displayed (step 52). FIG. 3 is an exemplary construction warranty program main page 100 of the construction warranty program 50, according to an embodiment of the invention. The construction warranty program main page 100 may be displayed on the Registered Contractor's computer, remotely located from the microcontroller 12 in response to any number of well-known methods (e.g. receipt of URL address). The construction warranty program main page 100 is configured to provide/display program information about the construction warranty program 50 and associated construction guarantee plans such as, for example, a list of the building/construction contractor organizations that participate in the construction warranty program, how the construction warranty program 50 is structured, the criteria required to participate in the construction warranty program 50, how the Registered Contractor should craft a Contract between himself/herself and the Purchaser, and the cost to the Registered Contractor for acquiring the construction guarantee plan for inclusion in a Contract between the Registered Contractor and the Purchaser of the Registered Contractor's services. The construction warranty program main page 100 may also be adapted to allow the Purchaser to access a contractor referral list. The program information may also be provided via pull-down lists and links displayed on the construction warranty program main page. In addition, the construction warranty program main page 100 also provides fields or links to fields to enable the Registered Contractor to enter his/her username and password. A valid user name and password allows the Registered Contractor to participate in the construction warranty program 50, and links the Registered Contractor to his/her building/construction contractor organization.

In a preferred embodiment, the construction warranty program main page 100 may be hosted by the Contractor's building/construction contractor organization. It is contemplated however, the construction warranty program main page 100 may be hosted by a third party administering the construction warranty program 50 (e.g., Build Wiser Today) in conjunction with an insurance underwriter. In such an arrangement, the insurance underwriter receives the largest percentage of the monies paid by the Registered Contractor, while the third party and the Contractor's building/construction contractor organization receive smaller percentages of the monies paid.

As mentioned above, the Registered Contractor is required to maintain good standing with his/her building/construction contractor organization in order to participate in the construction warranty program 50. Further, in order to participate in the construction warranty program 50, the Registered Contractor is required to utilize, as a rider to the subsequent Contract between the Purchaser and the Registered Contractor, the provisions of the construction guarantee plan selected via the construction warranty program 50. Such provisions may include a statement as to the rating of the insurance company underwriting the construction warranty program 50, who is eligible to participate in the construction warranty program 50, follow-up requirements by the Registered Contractor (e.g., must submit a copy of the executed Contract to the building/construction contractor organization or to the third-party), the cost of or premium for the selected construction guarantee plan (e.g., one percent of the Contract price, paid by the Registered Contractor and included or passed along as a cost to the Purchaser in the Contract), a payment schedule for the selected construction guarantee plan premium, and disclaimers as to what is not covered under the construction guarantee plan (e.g., claims for bodily injury, property damage, product/workmanship defects).

The provisions of each of the construction guarantee plans also address dispute related issues and may therefore include dispute resolution requirements in the event of a dispute, suggested mediators, what the losing party should pay, how the damaged party will be compensated, deductible amounts, requirements for a replacement contractor, compensation in the event that a replacement contractor is unable to perform the services within the defined Contract prices, and the length of the construction guarantee plan. In addition, the provisions of each of the construction guarantee plans clearly indicate that in a dispute situation, the Purchaser will be made whole (either by comparable services or payment by the construction warranty program insurance underwriter) or the Registered Contractor will recover payment (by the construction warranty program insurance underwriter) for contracted services performed.

Referring again to FIG. 2, when the microcontroller 12 detects entry a valid Registered Contractor password (step 54), the microcontroller 12 causes a construction guarantee selection page to be displayed (step 56) if the Registered Contractor is determined to be in good standing. The construction guarantee selection page enables the Contractor to select a construction guarantee plan from a list of one or more construction guarantee plans provided by the construction warranty program 50. In the preferred embodiment, the construction guarantee selection page may be hosted by the Contractor's building/construction contractor organization. It is contemplated however, that the construction guarantee selection page may be hosted by the third party administering the construction warranty program 50 as discussed above.

Upon detecting selection of a construction guarantee plan from among the list of the one or more construction guarantee plans (step 58), the microcontroller 12 displays the selected construction guarantee plan with an associated identifying serial number (step 60). The identifying serial number is associated with the Registered Contractor's selected construction guarantee plan and is further provided for Registered Contractor payment and administration follow-up purposes. Selection of the construction guarantee plan indicates that the Contractor has agreed to purchase the selected construction guarantee plan and abide by the rules of the construction warranty program 50. The Registered Contractor may then download the selected construction guarantee plan for inclusion in the Contract between the Registered Contractor and the Purchaser.

The microcontroller 12 then causes an invoice or bill to be sent for payment of the selected construction guarantee plan by the Registered Contractor (step 62). One of any number of invoice methods may be used to secure payment for the selected construction guarantee plan by the Registered Contractor. For example, the Contractor's building/construction contractor organization may provide the invoice to the Contractor, collect the monies and then forward the monies to the third party administering the construction warranty program 50. Alternatively, the building/construction contractor organization may notify the third party of the purchase of the selected construction guarantee plan and the third party may collect the monies.

Finally, the microcontroller 12 enables activation of the selected construction guarantee plan without verifying that the Registered Contractor has working capital equivalent to the Contract Price (step 64). Thus, unlike the traditional surety bonds where most building contractors are required to provide evidence of adequate equity or working capital equal to between ten and one-hundred percent of the Contract price, the selected construction guarantee plan provided via the construction warranty program 50 does not require that the Registered Contractor provide such evidence.

What is claimed is:

1. A system for providing a construction warranty program, the construction warranty program including a number of construction warranty plans available to a plurality of registered contractors in good standing with a participating contractor organization, the system comprising:
a host apparatus including a first microcontroller having a microprocessor and a memory operatively coupled to the microcontroller; and
an intelligent remote user device operatively coupled to the host apparatus, the intelligent remote user device including a display, an input device and a second microcontroller operatively coupled to the display and the input device, wherein first the microcontroller is adapted to:
cause a construction warranty program main page to be displayed on the intelligent remote user device;
cause a construction warranty selection page to be displayed on the remote intelligent device in response to detecting entry of valid contractor identity information via the construction warranty program main page, the construction warranty selection page including a list of at least one available construction warranty plans, the list of at least one available construction warranty plans purchasable by a registered contractor associated with the entered valid contractor identity information, purchasing a construction warranty program by the registered contractor enabling a payment guarantee to the registered contractor by a purchaser of the registered contractor's services identified in a service contract and enabling a service performance guarantee by the registered contractor to the purchaser for the registered contractor's services identified in the service contract; and
enable a construction warranty plan of the list of at least one available construction warranty plans to be provided to the registered contractor without verifying working capital equivalent to a contract price of the service contract.

2. The system of claim 1, wherein the first microcontroller is further adapted to:
prior to enabling the construction warranty plan, cause the construction warranty plan to be displayed to the registered contractor in response to detecting a selection from the construction warranty selection page by the registered contractor, the construction warranty plan including an identifying serial number; and
cause an invoice to be provided to the registered contractor for the construction warranty plan.

3. The system of claim 1, wherein the construction warranty plan is enabled upon receipt of payment for the construction warranty plan from the registered contractor.

4. The system of claim 3, wherein the registered contractor is required to utilize as a rider to the service contract, provisions of the enabled construction warranty program.

5. The system of claim 3, wherein the payment for the construction warranty plan is equal to one percent of the service contract value.

6. The system of claim 1, wherein the construction warranty plan is enabled prior to receipt of payment for the construction warranty plan from the registered contractor, payment for the construction warranty plan from the registered contractor provided via a participating contractor organization of the registered contractor.

7. The system of claim 1, wherein the construction warranty program main page is further configured to include general construction warranty program information, a list of participating contractor organizations, requirements for purchasing the construction warranty plan and text boxes to enable entry of the valid contractor identity information.

8. The system of claim 1, wherein the construction warranty program main page is further configured to include links selectable by the purchaser to access information about the construction warranty plan provided to the registered contractor.

9. The system of claim 1, wherein the entered valid contractor identity information includes as user name and password and allows he registered contractor to participate in the construction warranty program and links the registered contractor to the participating contractor organization of the registered contractor.

10. A method for providing a construction warranty program, the construction warranty program including a number of construction warranty plans available to a plurality of registered contractors in good standing with a participating contractor organization, the system comprising:
causing a construction warranty program main page to be displayed to a registered contractor of the plurality of registered contractors;
causing a construction warranty selection page to be displayed to the registered contractor in response to detecting entry of valid contractor identity information of the registered contractor via the construction warranty program main page, the construction warranty selection page including a list of at least one available construction warranty plans, the list of at least one available construction warranty plans purchasable by the registered contractor associated with the entered valid contractor identity information, purchasing a construction warranty program by the registered contractor enabling a payment guarantee to the registered contractor by a purchaser of the registered contractor's services identified in a service contract and enabling a service performance guarantee by the registered contractor to the purchaser for the registered contractor's services identified in the service contract; and
enabling a construction warranty plan of the list of at least one available construction warranty plans to be provided to the registered contractor without verifying working capital equivalent to a contract price of the service contract.

11. The method of claim 10, further comprising:
prior to enabling the construction warranty plan, causing the construction warranty plan to be displayed to the registered contractor in response to detecting a selection from the construction warranty selection page by the registered contractor, the construction warranty plan including an identifying serial number; and
causing an invoice to be provided to the registered contractor for the construction warranty plan.

12. The method of claim 10, wherein the construction warranty plan is enabled upon receipt of payment for the construction warranty plan from the registered contractor.

13. The method of claim 12, wherein the registered contractor is required to utilize as a rider to the service contract, provisions of the enabled construction warranty program.

14. The method of claim 12, wherein the payment for the construction warranty plan is equal to one percent of the service contract value.

15. The method of claim 10, wherein the construction warranty plan is enabled prior to receipt of payment for the construction warranty plan from the registered contractor, payment for the construction warranty plan from the registered contractor provided via a participating contractor organization of the registered contractor.

16. The method of claim 10, wherein the construction warranty program main page is further configured to include general construction warranty program information, a list of participating contractor organizations, requirements for purchasing the construction warranty plan and text boxes to enable entry of the valid contractor identity information.

17. The method of claim 10, wherein the construction warranty program main page is further configured to include links selectable by the purchaser to access information about the construction warranty plan provided to the registered contractor.

18. The method of claim 10, wherein the entered valid contractor identity information includes as user name and password and allows he registered contractor to participate in the construction warranty program and links the registered contractor to the participating contractor organization of the registered contractor.
